(19) United States
(12) Patent Application Publication
(10) Pub. No.: US 2023/0162224 A1
(43) Pub. Date: May 25, 2023

(54) REWARDS SYSTEM MAINTENANCE

(71) Applicant: Allstate Insurance Company, Northbrook, IL (US)

(72) Inventors: Edward A. Biemer, Glencoe, IL (US); Sarah Inciong, Dundee, IL (US)

(21) Appl. No.: 18/100,207

(22) Filed: Jan. 23, 2023

Related U.S. Application Data
(63) Continuation of application No. 14/543,311, filed on Nov. 17, 2014, now abandoned.

(51) Int. Cl. G06Q 30/0226; G06Q 40/08

(52) U.S. Cl. CPC G06Q 30/0226; G06Q 40/08

(57) ABSTRACT

Methods, computer-readable media, software, and apparatuses provide a system for determining rewards, creating and maintaining records of rewards, and communicating positive news (such as the receipt of rewards) to users. The system may include computing devices associated with a user, vehicle, and/or backend system. The system may detect events, such as events related to a user's driving behavior, and determine whether to issue rewards. The system may also determine to issue rewards if no positive news has been provided for some time. Further, the system may determine the particular rewards to issue based on various algorithms, user preferences, user characteristics, and/or policy characteristics. Moreover, the system may create, edit, and/or store a record of issued rewards in, for example, a rewards bank, and notify users of the rewards.

### CROSS-REFERENCE TO RELATED APPLICATIONS

The present application is a continuation of and claims priority to U.S. patent application Ser. No. 14/543,311 filed on Nov. 17, 2014, which is incorporated by reference in its entirety herein.

### FIELD OF ART

Aspects of the disclosure generally relate to methods and computer systems, including one or more computers particularly configured and/or executing computer software. More particularly, aspects of this disclosure relate to maintaining a system for rewarding policy holders.

### BACKGROUND

People purchase insurance policies to protect their investments in case of possible damage. For example, people purchase automobile insurance to offset the cost of repairs in case their vehicles are involved in an accident. In exchange for insurance, people may pay premiums at set intervals (e.g., monthly, semi-annually, or annually basis). In some cases, those insured may not receive anything in return unless their property (e.g., automobile) becomes damaged. This may frustrate some of those insured, and may cause some people to switch insurance companies and/or drop their insurance coverage altogether.

Insurance companies may aim to build a large pool of customers so that the premiums from all customers cover the costs of insuring the customers in the event their property is damaged or they become liable for the damaged property of others. To accomplish this, insurance companies rely on having customers that are of little or no cost, such as customers that avoid car accidents. Conventionally, auto-insurance companies have tried to estimate which customers might be involved in more risky driving behavior based on various factors. Recently, some auto-insurance companies have offered devices that can be installed in vehicles so that a risk assessment may be more accurately determined. Based on the data collected by such devices, insurance companies have evaluated the driving behavior of people to assess their risk and determine an appropriate insurance cost and premium. In some cases, insurance companies have offered lower insurance premiums or discounts to people exhibiting good driving behavior. While this may have helped some insurance companies to retain customers, further methods, devices, software, and systems for attracting and retaining customers, and in particular low-cost customers, are still in demand.

### BRIEF SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of the disclosure address one or more of the issues mentioned above by disclosing methods, computer readable storage media, software, systems, and apparatuses for providing a rewards management system that determines rewards, allocates rewards, notifies users of rewards, and maintains records of rewards. Rewards may be provided based on a driving behavior of users and/or as a result of non-driving events, such as monitoring another's driving behavior, visiting a website, adding a vehicle to an insurance policy, etc. Rewards may be provided as a result of a lapse of time as well so that users (e.g., customers) may intermittently (e.g., periodically) receive positive news from a company (e.g., insurance company) even if users have not otherwise earned rewards.

Aspects of this disclosure provide a system comprising a first computing device associated with a vehicle and a user, a rewards bank, and a second computing device. The first computing device (e.g., a cell phone, a device plugged into the vehicle, etc.) may be configured to collect drive data. The rewards bank (e.g., a database or other storage device) may be configured to maintain records of rewards. The second computing device may be configured to receive the drive data from the first computing device; analyze the drive data to determine whether a predefined event (e.g., hard braking event, sharp turning event, speeding event, etc.) has occurred; determine whether the user has earned a reward based on the predefined event in response to determining that the predefined event has occurred; determine the reward; store the reward in association with an account of the rewards bank that is associated with the user; and notify the user that the reward has been earned. Determining whether the user has earned the reward may include determining whether a drive score, which may be calculated based on the drive data, exceeds a threshold. In some embodiments, determining whether the user has earned the reward may include identifying the user; determining that the user has earned the reward if the user is younger than a predetermined age or has been driving for less than a predetermined amount of time; and determining that the user has not earned the reward if the user is older than the predetermined age or has been driving for greater than the predetermined amount of time. Determining the reward may include determining a type of the reward and a value (e.g., cash value, percentage of a discount, etc.) or quantity (e.g., number of points) of the reward. For example, if the reward is in the form of points, the second computing device may be configured to determine a number of points based on a drive score determined from the drive data. Notifying the user may include transmitting at least one of an email, a text message, a push notification, or a voice message. In some embodiments, the user may be notified according to a schedule set by the user. For example, the user may specify that they wish to be notified daily, weekly, monthly, etc. and/or what times (e.g., in the morning, afternoon, evening, etc. on a Monday, Tuesday, etc.) they wish to be notified. The notification may indicate a type of the reward and/or a value or quantity of the reward. The second computing device may be further configured to determine whether a predetermined amount of time has elapsed since a last time the user was sent positive news (e.g., received rewards) in response to determining that the user has not earned the reward. Further, the second computing device may be configured to select a reason for communicating with the user in response to determining that the predetermined amount of time has elapsed. The system may further include a third computing device configured to detect a non-driving event, wherein the second computing device is further configured to determine whether the user has earned a second reward based on an occurrence of the non-driving event. The non-driving event may include monitoring, by a superior, a subordinate's driving behavior. For example, a parent may monitor the driving behavior of his/her child thereby causing a non-driving event that may trigger rewards to be allocated to the parent's account in the rewards bank. The non-driving event may also include visiting a website, such as the website of an insurance company, reviewing a driving history, and/or editing/updating policy (e.g., insurance policy) information. The rewards bank may be configured to store, in association with a single account, information identifying rewards accumulated by a group of people (e.g., a group of friends or a group of people on the same insurance policy). The rewards bank may be configured to maintain the records of rewards on an individual basis, a per household basis, or per insurance policy basis.

Aspects of the disclosure also provide the computing devices of the system as well as the computer readable media of those computing devices that store a rewards management program or module. Specifically, aspects of the disclosure provide a computing device including a network interface configured to communicate with at least one first computing device and at least one second computing device and at least one processor. The at least one processor may be configured to receive, via the network interface, a first indication from the at least one first computing device that a driving event occurred or a second indication from the at least one second computing device that a non-driving event occurred; determine whether the driving event or non-driving event triggers allocation of a reward for a particular user; determine the reward; store the reward in association with an account of a database that is associated with the particular user; and transmit a notification indicating that the reward has been allocated. Further, the at least one processor may be configured to determine whether a predetermined amount of time has elapsed since a last time the particular user received any rewards, and transmit a message to the particular user, the message indicating that the particular user has been given a reward.

Aspects of the disclosure further provide a method of allocating rewards and providing positive news. For example, aspects provide a method including determining an occurrence of a driving or non-driving event; determining, by a computing device, whether the driving event or non-driving event triggers allocation of a reward for a user; determining the reward based on a characteristic or preference of the user in response to determining that the driving event or non-driving event triggers allocation of the reward; storing the reward in association with an account associated with the user; transmitting, to the user, a first notification indicating that the reward has been added to the account because of the driving event or non-driving event; and transmitting, to the user, a second notification indicating that another reward has been added to the account after a predetermined amount of time has elapsed since the transmitting of the first notification.

Of course, the methods and systems of the above-referenced embodiments may also include other additional elements, steps, computer-executable instructions, or computer-readable data structures. In this regard, other embodiments are disclosed and claimed herein as well. The details of these and other embodiments of the present invention are set forth in the accompanying drawings and the description below. Other features and advantages of the invention will be apparent from the description, drawings, and claims.

### BRIEF DESCRIPTION OF THE DRAWINGS

The present invention is illustrated by way of example and is not limited by the accompanying figures in which like reference numerals indicate similar elements and in which:

FIG. 1 is a block diagram of an example computing device that may be used according to an illustrative embodiment of the present disclosure.

FIG. 2 illustrates an example network environment in which a system in accordance with the present disclosure may be implemented.

FIG. 3 illustrates another example network environment in which a system in accordance with the present disclosure may be implemented.

FIGS. 4A, 4B, 4C, and 4D are diagrams illustrating data structures in accordance with aspects of the present disclosure.

FIG. 5 illustrates a flow diagram of an example process in accordance with aspects of the present disclosure.

FIG. 6 illustrates a flow diagram of an example process in accordance with aspects of the present disclosure.

FIG. 7 illustrates a flow diagram of an example process in accordance with aspects of the present disclosure.

### DETAILED DESCRIPTION

In accordance with various aspects of the disclosure, methods, computer-readable media, software, and apparatuses are disclosed that provide a rewards management system for determining rewards, notifying users (e.g., insurance policy holders) of rewards, tracking allocation and redemption of rewards, and generating positive news. The rewards management system may be integrated across a plurality of platforms. For example, the rewards management system may determine rewards based on good driving behavior and allow the rewards to be redeemed in the form of a discount on home insurance. In some embodiments, the rewards management system may incorporate or interface with a vehicle telematics system so that data representing driving behavior may be collected and evaluated. As such, an aspect of the rewards management system may include rewarding drivers for demonstrating good or safe driving behavior. The rewards management system may determine drive scores and reward drivers based on the determined scores. The rewards management system may also incorporate or interface with other insurance systems such as a web portal through which user may view their insurance policies. As such, an aspect of the rewards management system may include publishing rewards online for users and/or others (e.g., peers, parents, insurance agents, etc.) to view. For example, the rewards management system may provide a leaderboard to indicate which users have received the most rewards. In some embodiments, the rewards management system may provide leaderboards for different groups or policies. For example, the rewards management system may provide a web page publishing a leaderboard for a specific group of users competing with one another so the users may see how others in the group are performing and which rewards others have received. In some embodiments, the leaderboard may also be viewed through an application running on a mobile computing device, such as a mobile phone.

Rewards may be awarded for non-driving related events as well as driving related events. In some embodiments, rewards may be awarded for viewing a driving history, viewing a company's website, commenting on a social network (e.g., “liking” or “tweeting” certain content), completing a survey, or any combination thereof. In some embodiments, the rewards management system may reward a person for monitoring another person's driving behavior. For example, the rewards management system may reward a parent for monitoring their child's behavior or a company that monitors the driving behavior of their employees (e.g., driving behavior of truck drivers). In this manner, the rewards management system may encourage others to become involved in and interested in deterring poor driving behavior that may lead to a greater risk of accidents (and therefore greater costs to insurance companies).

The rewards management system may allocate and manage various types of rewards. The rewards may be in the form of points, monetary notes (e.g., cash, checks, etc.), discounts or coupons, gift cards (e.g., gift cards related to a particular vehicle of the user, such as particular tires for the user's car), goods and services (e.g., roadside assistance services), insurance specific products, entry into a lottery, or any combination thereof. For example, for a single action or event, the rewards management system may allocate points to a bank of a user and enter that user into a lottery to win a prize or more points (e.g., bonus points). In some embodiments, users (e.g., insurance policy holders/customers) may choose the type of rewards they wish to receive or designate several options of rewards they wish to receive. Also, rewards in the form of points may be used to redeem other forms of rewards. For example, points may have a cash value or may be used to get a discount on insurance or non-insurance goods/services. In some embodiments, points may be given hyper-values (e.g., each point may count as two points) if they are used to purchase goods or services from a particular company or vendor.

Further, the rewards management system may control the redemption of rewards. In some embodiments, rewards may be redeemable immediately upon receipt. In other embodiments, redemption of rewards may be restricted until some future time. The future time may depend on the occurrence of a driving event (e.g., receipt of a future drive score above 90), a non-driving event (e.g., renewal of an insurance policy), or more simply the lapse of a set amount of time (e.g., rewards may be redeemable after 6 months).

The rewards management system may place rewards in a rewards bank (e.g., points bank) for a particular individual, for a household, for an insurance policy, and/or for a group. In other words, the rewards may be provided on a per individual and/or per group basis. Some users may be more pleased to receive rewards that are just for them, while other users may be more pleased to share rewards with others. Users may choose whether they wish to pool their rewards together or keep their rewards separate.

In some embodiments, the rewards management system may provide rewards based on policy characteristics and/or user (e.g., policy holder) characteristics. For example, the rewards management system may provide different rewards for different people in response to a similar or the same action. For example, a young person (e.g., teenager just learning to drive) may receive double the points that an older person might receive for driving under the speed limit. Also, insurance policy holders with a certain type of policy may earn triple the points that another person might earn with a different policy. Still, in some embodiments, the number of points awarded may be the same for all policy holders regardless of policy characteristics or policy holder characteristics.

Rewards may also be provided as a function of the overall amount of rewards available and/or overall amount of rewards dispersed. For example, the rewards management system may track how many of a certain type of good is awarded so that the rewards management system does not award a good that it cannot deliver. The rewards management system may also track the overall amount of rewards dispersed so, for example, the system does not give out more rewards than it can afford. For example, if a company brings in “x” amount of dollars one month, the rewards management system may scale rewards to make sure that the amount of rewards distributed the next month does not exceed the “x” amount of dollars. Accordingly, in determining an amount and type of reward to provide, the rewards management system may factor in revenues and profits of a company.

In addition, the rewards management system may determine when to notify users (e.g., policy holders or policy members) of rewards. An aspect of the rewards management system may include intermittently (e.g., periodically) providing users with positive news regarding their insurance policy. By contacting users with positive news, the rewards management system may create a positive feeling on the part of customers towards their insurance policy (and insurance company), and therefore, may assist in attracting and retaining customers. To facilitate the intermittent contacting of users, the rewards management system may track how users are contacted and when they are contacted. The rewards management system may also be used to evaluate the impact that providing positive news (e.g., providing rewards) has on customer acquisition and retention. For example, the rewards management system may detect a case where a customer was sent a notification of rewards one day and a friend of the customer opened a policy within a week. Additionally, or alternatively, the rewards management system may determine a difference between a probability that a customer who was sent five rewards notifications in a year will renew his/her policy and a probability that a customer who was sent three rewards notifications in a year will renew his/her policy. Using evaluations of the impact of rewards notifications, the rewards management system may determine how often certain users are to be contacted with rewards notifications. In this regards, the rewards management system may be configured to contact various users at various intervals, such as daily, weekly, bi-weekly, monthly, semi-annually, annually, etc. Also, in some cases, the rewards management system may notify users immediately of their receipt of a reward. Moreover, users may have a say in how and when they receive notifications of rewards.

The rewards management system may include a computing device executing a program/application that collects drive data and notifies a user of rewards. For example, the rewards management system may be implemented with a smartphone that executes a program/application for collecting drive data (e.g., GPS data, accelerometer data, gyroscope data, etc.) representing a driving behavior of a user, evaluating the drive data to determine a drive score, determining rewards based on the drive score, and/or notifying the user of the rewards. In this example, the smartphone may communicate with other computing devices of the rewards management system to outsource any of the aforementioned steps and/or to report the rewards received so that the rewards may be tracked and redeemed.

In the following description of the various embodiments of the disclosure, reference is made to the accompanying drawings, which form a part hereof, and in which is shown by way of illustration, various embodiments in which the disclosure may be practiced. It is to be understood that other embodiments may be utilized and structural and functional modifications may be made.

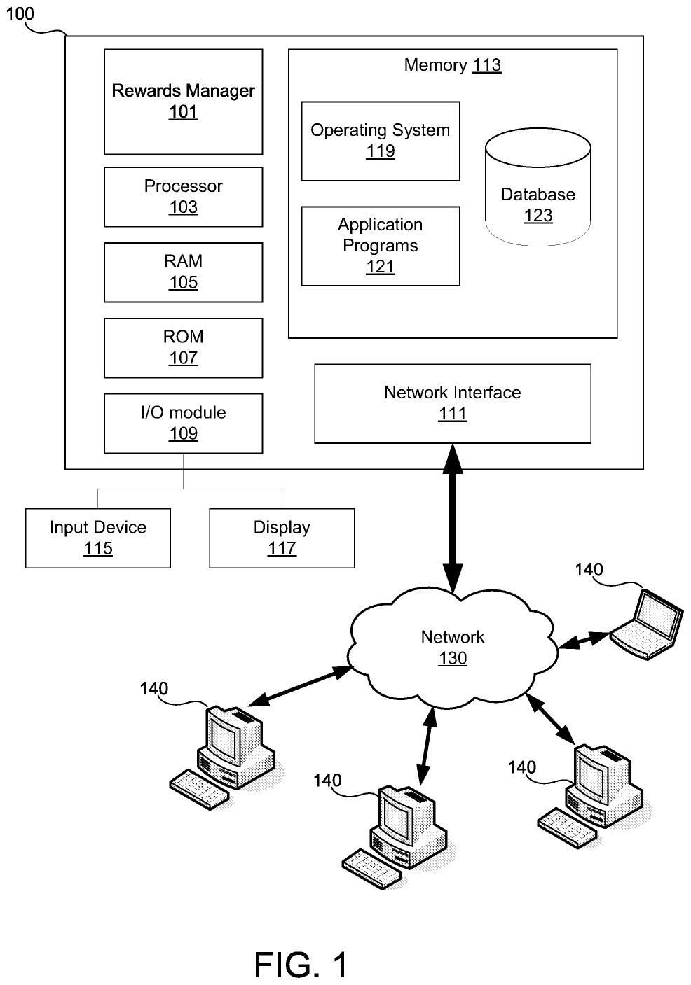

In one or more arrangements, teachings of the present disclosure may be implemented with a computing device. FIG. 1 illustrates a block diagram of an example computing device 100 that may be used according to an illustrative embodiment of the present disclosure. The computing device 100 may be similar to any available computing device, such as a personal computer (e.g., a desktop computer), server, laptop computer, notebook, tablet, smartphone, etc. The computing device 100 may have a rewards manager 101 for performing methods and executing instructions of the rewards management program described herein. The rewards manager 101 may be implemented with one or more processors and one or more storage units (e.g., databases, RAM, ROM, and other computer-readable media), one or more application specific integrated circuits (ASICs), and/or other hardware components. Throughout this disclosure, the rewards manager 101 may refer to the software and/or hardware used to implement the rewards manager 101. The one or more processors of the rewards manager 101 may operate in addition to or in conjunction with another general processor 103 of the computing device 100. Both the rewards manager 101 and the processor 103 may be capable of controlling operations of the computing device 100 and its associated components, including RAM 105, ROM 107, an input/output (I/O) module 109, a network interface 111, and memory 113.

The I/O module 109 may be configured to be connected to an input device 115, such as a microphone, keypad, keyboard, touchscreen, and/or stylus through which a user of the computing device 100 may provide input data. The I/O module 109 may also be configured to be connected to a display device 117, such as a monitor, television, touchscreen, etc., and may include a graphics card. The display device 117 and input device 115 are shown as separate elements from the computing device 100, however, they may be within the same structure. Using the input device 115, system administrators may update various aspects of the rewards management program, such as rules for identifying events that trigger rewards, rules for determining rewards, and rules for notifying users (e.g., insurance policy holders) of rewards. On some computing devices 100, the input device 115 may be operated by users (e.g., customers) to interact with the rewards management program, including providing user information and/or preferences (e.g., preferences related to how and when to receive notifications), checking status of rewards, redeeming rewards, etc., as described herein. Meanwhile, the display device 117 may assist the system administrators and users to confirm/appreciate their inputs.

The memory 113 may be any computer readable medium for storing computer executable instructions (e.g., software). The instructions stored within memory 113 may enable the computing device 100 to perform various functions. For example, memory 113 may store software used by the computing device 100, such as an operating system 119 and application programs 121, and may include an associated database 123.

The network interface 111 allows the computing device 100 to connect to and communicate with a network 130. The network 130 may be any type of network, including a local area network (LAN) and/or a wide area network (WAN), such as the Internet, a cellular network, or satellite network. Through the network 130, the computing device 100 may communicate with one or more other computing devices 140, such as laptops, notebooks, smartphones, personal computers, servers, etc. The computing devices 140 may also be configured in a similar manner as computing device 100. In some embodiments the computing device 100 may be connected to the computing devices 140 to form a “cloud” computing environment.

The network interface 111 may connect to the network 130 via communication lines, such as coaxial cable, fiber optic cable, etc. or wirelessly using a cellular backhaul or a wireless standard, such as IEEE 802.11, IEEE 802.15, IEEE 802.16, etc. In some embodiments, the network interface may include a modem. Further, the network interface 111 may use various protocols, including TCP/IP, Ethernet, File Transfer Protocol (FTP), Hypertext Transfer Protocol (HTTP), etc., to communicate with other computing devices 140.

FIG. 1 is an example embodiment of a computing device 100. In other embodiments, the computing device 100 may include fewer or more elements. For example, the computing device 100 may use the general processor(s) 103 to perform functions of the rewards manager 101, and thus, might not include a separate processor or hardware for the rewards manager 101. Additionally, or alternatively, the computing device 100 may be a mobile device (e.g., a smartphone, tablet, etc.), and thus, may also include various other components, such as a battery, speaker, and/or antennas (not shown). Also, the computing device 100 may be a vehicle computing device (either installed by a vehicle manufacturer or as an aftermarket part) having vehicle compatible elements, such as a port for an on-board diagnostic connector or ports for other vehicle sensors (e.g., tire pressure sensors, engine temperature sensors, etc.). For example, the computing device 100 could be a vehicle's computer or a device plugged into the vehicle's computer for use in vehicle telematics.

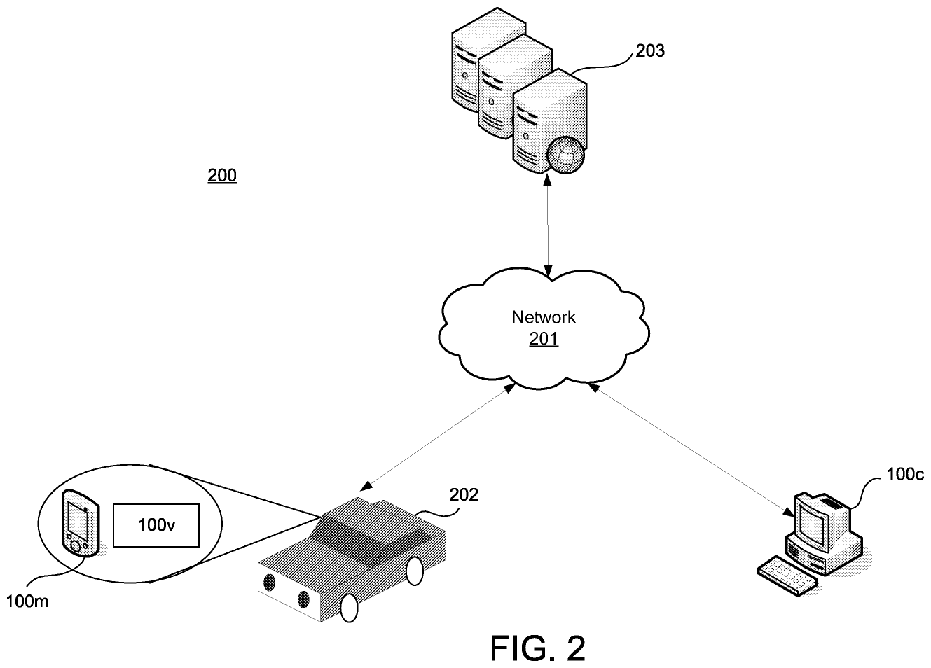

The methods and software for establishing, maintaining, and managing a rewards system as disclosed herein may be implemented on one or more computing devices 100 used in various network environments. FIG. 2 illustrates an example network environment 200 for implementing methods according to the present disclosure. As shown in FIG. 2, the network environment 200 may include a network 201 configured to connect computing devices within or associated with a vehicle 202, other customer computing devices 100c, and one or more application servers 203. Collectively, these computing devices may form at least a part of a rewards management system. The network 201 may be any type of network, like the network 130 described above, and use one or more communication protocols (e.g., protocols for the Internet (IP), Bluetooth, cellular communications, satellite communications, etc.) to connect computing devices and servers within the network environment 200 so they may send and receive communications between each other. In particular, the network 201 may include a cellular network and its components, such as cell towers. Accordingly, for example, a mobile computing device 100m (e.g., a smartphone) of a person in vehicle 202 may communicate, via a cellular backhaul of the network 201, with an application server 203 to report drive data representing a driving behavior of a driver of the vehicle 202. And, in the opposite direction, the application server 203 may communicate, via the cellular backhaul of the network 201, with the mobile computing device 100m to notify a user of the mobile computing device 100m of rewards. While FIG. 2 illustrates that the mobile computing devices 100m may connect with the network 201 while it is in the vehicle 202, it should be understood that the same mobile computing device 100m may connect to the network 201 even if it is removed from the vehicle 202.

The vehicle 202 may be, for example, the vehicle of a customer of an insurance company or a vehicle covered by an insurance policy of an insurance company. Although FIG. 2 illustrates only one vehicle 202, the rewards management system may be configured to communicate with multiple vehicles 202 simultaneously so that it may receive drive data simultaneously and notify users of rewards simultaneously. Also, although FIG. 2 depicts the vehicle 202 as a car, the vehicle 202 may be any type of vehicle, including a motorcycle, bicycle, scooter, drone (or other automated device), truck, bus, boat, plane, helicopter, etc.

FIG. 2 also illustrates an example subsystem within the network environment 200. Specifically, FIG. 2 illustrates an example arrangement of computing devices that may exist within the vehicle 202. To depict these computing devices, FIG. 2 includes a view of the inside of the vehicle 202. As shown in FIG. 2, the vehicle 202 may include a mobile computing device 100m and/or a vehicle computing device 100v. In some embodiments, the mobile computing device 100m and vehicle computing device 100v may communicate with one another (e.g., via Bluetooth). The mobile computing device 100m may be any mobile computing device (e.g., a smartphone, tablet, etc.) that is associated with a driver or passenger of the vehicle 202. In particular, the mobile computing device 100m may belong to a customer of an insurance company who is enrolled in a service that allows the customer to obtain rewards based on their driving behavior.

The mobile computing device 100m may be configured in a similar manner to the computing device 100 of FIG. 1. Further, the mobile computing device 100m may be configured to execute a rewards management program that provides a user interface for viewing and redeeming rewards. The rewards management program may be a self-sufficient program or may be a module of another program, such as a program used to collected and/or evaluate drive data representing actions of a vehicle 202 and/or driving behavior of a driver of a vehicle 202. The rewards management program may be downloaded or otherwise installed onto the mobile computing device 100m using known methods. Different mobile computing devices 100m may install different versions of the rewards management program depending on their platform. For example, a mobile computing device 100m running the iOS™ operating system may download a different version of the rewards management program than a mobile computing device 100m running the ANDROID™ operating system.

Once installed onto the vehicle computing device 100m, a user may launch the rewards management program by, for example, operating buttons or a touchscreen on the mobile computing device 100m. Additionally, or alternatively, the mobile computing device 100m may be configured to execute a web browser (e.g., an application for accessing and navigating the Internet) to access a web page providing an interface for the rewards management system. In some embodiments, the mobile computing device 100m may also be configured to collect drive data. For example, the rewards management program or another program installed on the mobile computing device 100m may instructed the mobile computing device 100m to collect drive data using, e.g., its accelerometer, GPS, gyroscope, etc. Drive data may include vehicle telematics data or any other data related to events occurring during a vehicle's trip (e.g., an impact to a part of the vehicle, a deployed airbag, etc.). Drive data may also include location information, such as GPS coordinates, indicating the geographical location of the mobile computing device 100m.

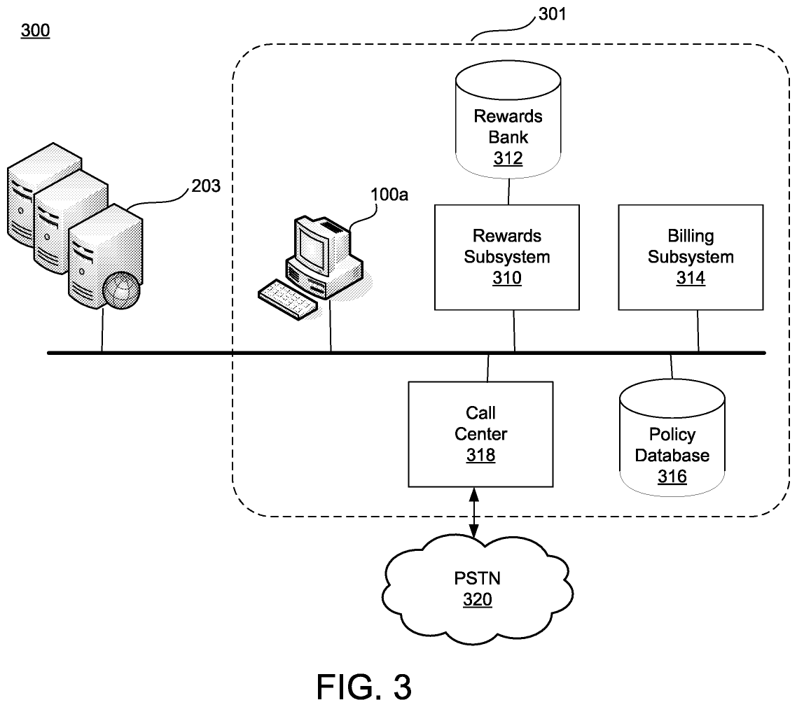

Although FIG. 3 depicts just one mobile computing device 100m within the vehicle 202, there may be more or less mobile computing devices 100m in some cases. For example, the people in the vehicle 202 might not have a mobile computing device 100m or might have left their mobile computing device 100m elsewhere. Also, if the vehicle is autonomous, there might not be any mobile computing device 100m. On the other hand, there may be multiple mobile computing devices 100m within a single vehicle 202. For example, the vehicle 202 may carry one or more passengers in addition to the driver, and each person may have one or more mobile computing devices 100m. In some embodiments, a passenger may receive rewards for riding with driver based on that driver's driving performance. By allowing customers to obtain rewards even as passengers, the rewards management system may reduce an insurance company's likelihood of liability by reducing the likelihood of its customers driving.

As mentioned above, the vehicles 202 may also include a vehicle computing device 100v. The vehicle computing device 100v may be configured in a similar manner to the computing device 100 of FIG. 1. Further, the vehicle computing device 100v may be configured to execute a rewards management program that provides a user interface for a customer to provide inputs to and receive outputs from the rewards management system. The rewards management program may be downloaded or otherwise installed onto the vehicle computing device 100v using known methods. Once installed onto the vehicle computing device 100v, a user may launch the rewards management program by, for example, operating buttons or a touchscreen on the dashboard of the vehicle 202. Additionally, or alternatively, the vehicle computing device 100v may be configured to execute a web browser to access a web page providing an interface for the rewards management system.

In some embodiments, the vehicle computing device 100v may be a device that is plugged into the vehicle's 202 on-board diagnostic (OBD) system (e.g., plugged in through an OBD II connector) or otherwise installed in the vehicle 202 in order to collect drive data using, e.g., its accelerometer, GPS, gyroscope, or any other sensor (either in the device or the vehicle 202). As mentioned above, this drive data may include vehicle telematics data or any other data related to events occurring during a vehicle's trip (e.g., an impact to a part of the vehicle, a deployed airbag, or other event triggered by a sensor of the vehicle 202). The vehicle 202 may have a GPS installed therein, and therefore, the vehicle computing device 100v may also collect GPS coordinates.

Further, the vehicle computing device 100v may be a system including multiple devices. For example, the vehicle computing device 100v may include the vehicle's OBD system and other computers of the vehicle 202. The vehicle computing device 100v may be configured to interface with one or more vehicle sensors (e.g., fuel gauge, tire pressure sensors, engine temperature sensors, etc.). The vehicle computing device 100v may also interface with the mobile computing device 100m via a wired connection (e.g., USB, OBD II connector, etc.) or a wireless connection (e.g., Bluetooth). In some embodiments, there might not be a vehicle computing device 100v installed in the vehicle 202 that is configurable to interface with the rewards management system, or the vehicle computing device 100v might not be able to communicate with any of the mobile computing devices 100m. Still, in some cases, the vehicle computing device 100v might be configured so that it only communicates with the mobile computing devices 100m within the same vehicle 202.

Although FIG. 2 illustrates both a mobile computing device 100m and a vehicle computing device 100v, in some embodiments only one of these devices may be used with the rewards management system to collect drive data. For example, a user (e.g., insurance policy holder) may choose whether she wishes to use her mobile phone to capture drive data or whether she wishes to have a device plugged into her vehicle 202 to collect drive data.

In some embodiments, one or more of the vehicles 202 may be autonomous or in an autonomous mode (e.g., auto-pilot mode). An autonomously controlled vehicle 202 may be controlled by its vehicle computing device 100v and/or a remote computing device. The vehicle computing device 100v may employ sensors for inputting information related to a vehicle's 202 surroundings (e.g., distance from nearby objects) and use the inputted information to control components of the vehicle 202 to steer the vehicle 202. Users remotely controlling the operation of the vehicle 202 may be rewarded based on how well they operate the vehicle 202.

In some embodiments, the rewards management system may include one or more of the application servers 203. An application server 203 may be configured to receive drive data and push notifications of rewards. An application server 203 may also allow computing devices 100 to access a web portal to review and/or redeem rewards. For example, an application server 203 may host a website that customers can visit to review their rewards, indicate preferred forms of rewards, redeem rewards, transfer rewards (e.g., transfer rewards to a friend or family member), and pool rewards (e.g., pool rewards with a group).

FIG. 2 also illustrates a customer computing device 100c. The customer computing device 100c may be any computing device used by a customer of, for example, an insurance company to execute a web browser to access the website described above or a rewards management program to communicate with the application server 203. For example, the customer computing device 100c may be a desktop computer, laptop, tablet, etc. that a customer uses to execute a web browser or other application to sign up for a rewards program, review rewards, indicate preferred forms of rewards, indicate when and how she wishes to be notified of rewards, redeem rewards, transfer rewards, and pool rewards.

In some embodiments, the customer computing device 100c may be used by a superior to review the driving performance of a subordinate. For example, a parent may use the customer computing device 100c to monitor and/or review the driving performance of her child (e.g., a teenager who has recently learned to drive). In some embodiments, the parent may be able to monitor the driving behavior while the child is driving. That is, drive data may be reported from the mobile computing device 100m or vehicle computing device 100v in real-time (e.g., while the child is driving) to the application server 203 or customer computing device 100c for the parent to monitor. The customer computing device 100c or application server 203 may detect when the parent (or other superior) is monitoring a child's driving (or subordinate's driving) so as to reward the parent for this action. As such, the rewards management system may encourage parents (and other superiors) to become involved in or interested in improving the driving behavior of their children (or other subordinates).

FIG. 3 illustrates another example network environment 300 for implementing methods according to the present disclosure. As shown in FIG. 3, the network environment 300 may include the application server 203 connected to a backend system 301. The backend system 301 may include an administrator computing device 100a, a rewards subsystem 310, a rewards bank 312, a billing subsystem 314, a policy database 316, and a call center 318. Each of these computing devices may also be considered to be a part of the rewards management system.

The administrative computing device 100a may be configured in a similar manner as the computing device 100 and may be used to configure other computing devices 100 within the rewards management system. For example, the administrative computing device 100a may be used by a web developer to build and/or update a website displaying rewards. Or, for example, the administrative computing device 100a may be used by a software developer to update a rewards management program to fix bugs and/or add new features.

The rewards subsystem 310 may include computing devices 100 and other equipment used by company (e.g., an insurance company) personnel. For example, the rewards subsystem 310 may include a reward points engine, which may be any computing device 100 configured to execute a rewards management program or module thereof (e.g., a computing device 100 with the rewards manager 101). The reward points engine may be configured to convert drive scores into points. Further, the reward points engine may be configured to convert points into a cash value and vice versa.

The rewards subsystem 310 may provide access to rewards and maintain records related to distribution and redemption of rewards. For example, when vehicle telematics data (e.g., drive data) is received by the application server 203, the application server 203 may route the received data to the rewards subsystem 310 for processing and evaluation to determine whether rewards have been earned. Also, for example, when a customer using a customer computing device 100c accesses the application server 203 to view rewards, the application server may forward the request to review to the rewards subsystem 310 for processing the request. Accordingly, the rewards subsystem 310 may handle a variety of tasks related to the access, maintenance, and management of rewards.

To facilitate access, maintenance, and management of rewards, the rewards subsystem 310 may store various tables. The rewards subsystem 310 may include one or more databases for associating bank identifiers (“Bank IDs”) with various other identifiers, such as policy identifiers (“Policy IDs”), web account identifiers (“MyAccount IDs”), service identifiers (“Service IDs”) for various services (such as a vehicle telematics service that a user has enrolled in), and/or device identifiers (“Device IDs”) for various devices (such as mobile computing devices 100m or vehicle computing devices 100v used to collect vehicle telematics data for a particular user/policy). Such associations may be represented by Table 1 below.

TABLE 1

| Bank IDs | Policy IDs | My Account IDs | Service IDs | Device IDs |
|---|---|---|---|---|
| 000123 | ABC-02 | john.doe | VehTel1 | Abcde123 |
| 000456 | DEF-03 | j.doe1 | VehTe12 | Edcba321 |
| 000789 | GHI-01 | Doe1 | VehTe13 | Wxyz123 |

The information in Table 1 could be broken down into multiple tables distributed across multiple databases. For example, one database could store Bank IDs in association with Policy IDs, whereas another database could store Bank IDs in association with device IDs. Also, it should be understood that a single Bank ID could be associated with multiple identifiers of the same type. For example, a single Bank ID could be associated with multiple Policy IDs so that customers with different policies may pool together rewards. Also, a single Bank ID could be associated with multiple Device IDs so that multiple users of the same household or policy can pool together rewards. For example, a parent may use one mobile computing device 100m (e.g., a first smartphone) to collect a set of drive data when the parent drives while a child may use another mobile computing device 100m (e.g., a second smartphone) to collect a set of drive data when the child drives, and rewards based on both sets of drive data can go into the same rewards/bank account (e.g., account with the same Bank ID).

The rewards subsystem 310 may maintain one or more tables, like Table 1 above, such that it can take requests from other subsystems and provide information on contents of the rewards bank 312 in response. For example, the rewards subsystem 310 may receive a request from an insurance agent inquiring about the amount of rewards that her customer has accumulated. The insurance agent may provide a Policy ID with the request, and the rewards subsystem 310 may use the Policy ID to determine the corresponding Bank ID. Once the rewards subsystem 310 determines the Bank ID, it can automatically provide information about the rewards associated with that Bank ID to the insurance agent.

Table 1 is used to illustrate some associations. It should be understood that many other types of information may be stored in association with Bank IDs. Also, the values of Table 1 are just examples, and many other values and data structures may be used to represent the information in Table 1. It should also be understood that information of Table 1 may be organized and stored in various manners using various data structures that allow associations between different pieces of data, and thus, allow for the data to be depicted in a row and column format if desired.

Still referring to FIG. 3, in some embodiments, the rewards subsystem 310 may maintain a rewards bank 312 to keep track of all types of rewards. The rewards bank 312 may store information on the types and amounts of rewards in association with Bank IDs. The rewards bank 312 may store rewards on a per person, per household, or other basis. In some embodiments, the rewards bank 312 may include a points bank that stores points awarded to users (e.g., insurance customers). The rewards subsystem 310 may add points to a user's account within the points bank as the user earns points (based on driving behavior or other actions/events). The rewards subsystem may also delete points from the points bank when the user chooses to redeem the points for, e.g., prizes or other goods/services (such as other insurance policies). In some embodiments, once points are entered into the points bank they might not be deleted unless they are redeemed or an account is canceled (e.g., an insurance policy is canceled). Points may be redeemed by visiting a particular website (which could be a third party website or a website of the same entity controlling the points bank) or ordering goods/services from a particular catalog, and using the points to make purchases. Alternatively, in some cases, even if a policy is canceled, the points may be retained (forever or for at least some period of time, such as 1 year) in the points bank in case the customer decides to return to the insurance company.

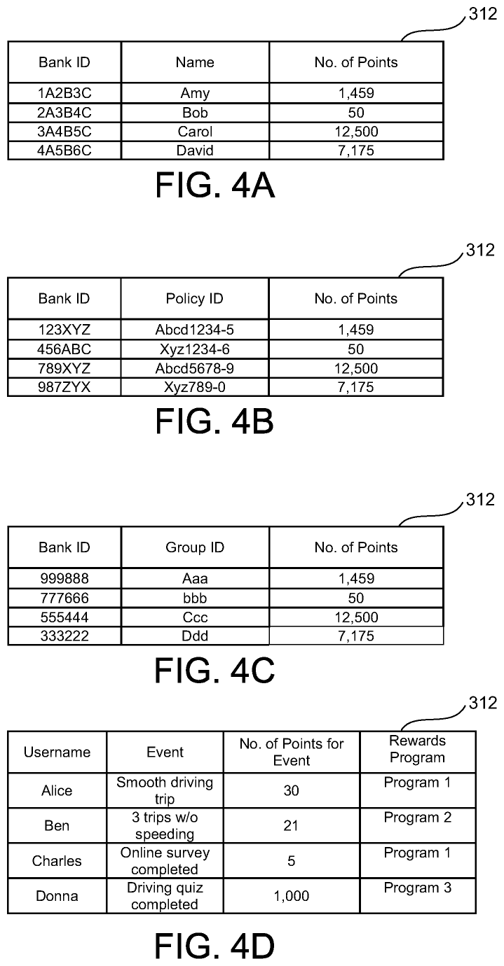

FIGS. 4A, 4B, 4C, and 4D provide tables to illustrate the various arrangements and data structures used to maintain the rewards bank 312. It should be understood that the values in the tables of FIGS. 4A-4D are examples, and that other values may be used. Also, it should be understood that the data structures of the rewards bank 312 may include or may be associated with additional information, such as insurance information (e.g., information regarding an insurance premium, insurance deductible, items insured, etc.) collected by an insurance company.

In FIG. 4A, the rewards bank 312 may store points on a per person basis. That is, each person enrolled in a service to receive points may have their own account within the rewards bank 312 so that any points that person earns is put into his/her account.

In comparison, in FIG. 4B, the rewards bank 312 may store points on a per policy or per household basis. A single insurance policy may insure the actions and property of a number of people living within the same household (e.g., a family). For example, a single insurance policy may provide coverage for a father's vehicle, a mother's vehicle, and a teenager's vehicle. The father, mother, and teenager may each earn points based on their respective driving performances, and those points may be accumulated within a single account with the rewards bank 312. The more people contributing to a single bank account, the greater the amount of points that bank account may accumulate. More points may be needed to obtain more valuable or more desired prizes (e.g., goods, services, etc.). Therefore, by pooling together their points, several individuals on the same policy or in the same household may be able to acquire the goods and/or services they desire.

FIG. 4C illustrates that the rewards bank 312 may store points on a per group basis, where members of the group can have different insurance policies. For example, teenagers in the same classroom or school may choose to pool their points together in a group account so that they can use the points to acquire a prize for the classroom or school or perhaps to make a donation on behalf of the classroom or school. Or, for example, different immediate families (having different insurance policies) belonging to the same extended family may choose to pool their points together in a group account so that they can use the points to acquire a prize the whole extended family may enjoy. It should be understood that other groups may be formed as well.

Although FIGS. 4B and 4C display a single (e.g., total) point value for each Bank ID, in some embodiments, the rewards bank 312 may also keep track of the number of points each individual or household/policy is contributing to the pool of points. For example, in a case where a father, mother, and daughter each contribute points to a single account, the rewards bank 312 may also store how many points were contributed by the father, how many points were contributed by the mother, and how many points were contributed by the daughter. Such information may be shared with the contributing individuals in various manners to stir up competition. For example, the rewards management system may send a notice to a daughter indicating that her mother just contributed 10 points to the account because of her safe driving. Further, the rewards bank 312 may also keep track of which points came from which programs/projects/services. For example, an account in rewards bank 312 associated with a single user may indicate that 200 points originated from use of a smartphone to capture drive data while 100 points originated from completing an online survey.

FIG. 4D illustrates yet another example data structure of the rewards bank 312. As shown in FIG. 4D, the rewards bank 312 may store a username in association with an event that earned a person points, a number of points earned for that event, and information indicating the rewards program that defines when and how many points are earned. For example, referring to FIG. 4D, Alice may have earned 30 points for driving to school without having a hard brake event in accordance with the rules of “Program 1.” In some examples, rewards may be earned over the course of multiple driving trips. For example, according to the rules of “Program 2,” Ben may have earned 21 points for completing three different trips without speeding. FIG. 4 illustrates that rewards may also be given for non-driving events. For example, Charles may earn 5 points for completing an online survey in accordance with the rules of “Program 1.” Also, Donna may earn 1,000 points for completing a driving quiz (offered on an app or online) in accordance with the rules of “Program 3.” From the example of FIG. 4D, it should be understood that there may be multiple rewards programs defining different rules that govern when, how, how many, etc. rewards are earned/allocated. However, in some embodiments, a single program may exist, and therefore, the program identifier may not be included in the data structure.

The data structure in FIG. 4D may be associated with a Bank ID, Group ID, or Policy ID of FIG. 4B or 4C. For example, Alice, Ben, Charles, and Donna may all belong to the same group or be on the same policy. Each row in the tables of FIGS. 4B and 4C may be associated with a pointer that points to a data structure like the one shown in FIG. 4D. Accordingly, the number of points in FIGS. 4B and 4C may correspond to the total number of points in a corresponding data structure like that of FIG. 4D.

Further, each row in FIG. 4A may also be associated with a pointer that points to a data structure similar to the data structure of FIG. 4d. For example, a data structure similar to that of FIG. 4D may be stored in association with each person named (e.g., Amy, Bob, etc.) in FIG. 4A to keep track of the various events that may have earned each person points. In such case, data in the username column may not be stored as the events may be performed by the same person and thus the username would be the same for each event.

Returning to FIG. 3, in some embodiments, the rewards subsystem 310 may communicate with the billing subsystem 314 so that the rewards may be included with any billing matters. The billing subsystem 314 may include computing devices and other equipment used by billing personnel (book keepers, accountants, etc.) to manage billing for various goods and services. For example, the billing subsystem may include those components used to send bills for insurance premiums or deductibles to insurance customers. Such bills could include an amount of rewards earned by the customer so that the customer may receive at least some positive news along with their bill (which is generally seen as negative news). Moreover, the rewards subsystem 310 may notify billing of rewards so that the rewards may automatically be applied to customer bills. For example, the rewards subsystem 310 could notify billing that a customer received 10 points so that the billing subsystem 310 automatically deducts a certain amount from the customer's next bill or automatically sends money (e.g., cash or check) back to the customer.

The policy database 316 may include memory used to store insurance policy information, such as the name of a policy holder, names of others on the policy (e.g., children of the policy holder), property (e.g., vehicles, homes, etc.) on the policy, password and usernames, insurance claim information, driving records, etc. Although only one policy database is shown in FIG. 3, many databases may be used.

The call center 318 may include computing devices and other equipment (e.g., telephones) used by customer service representatives and other personnel to take phone calls from customers and potential customers or make calls to customers and potential customers to notify them of rewards or offer them rewards. As shown in FIG. 3, the call center may interface with the public switched telephone network (PSTN) 320 to take such phone calls. The customer service representatives may use computing devices to access user accounts of customers to assist them in enrolling in services, such as a service for receiving rewards. The customer service representatives may also provide assistance in editing/updating account information, redeeming rewards, transferring rewards, pooling together rewards, etc.

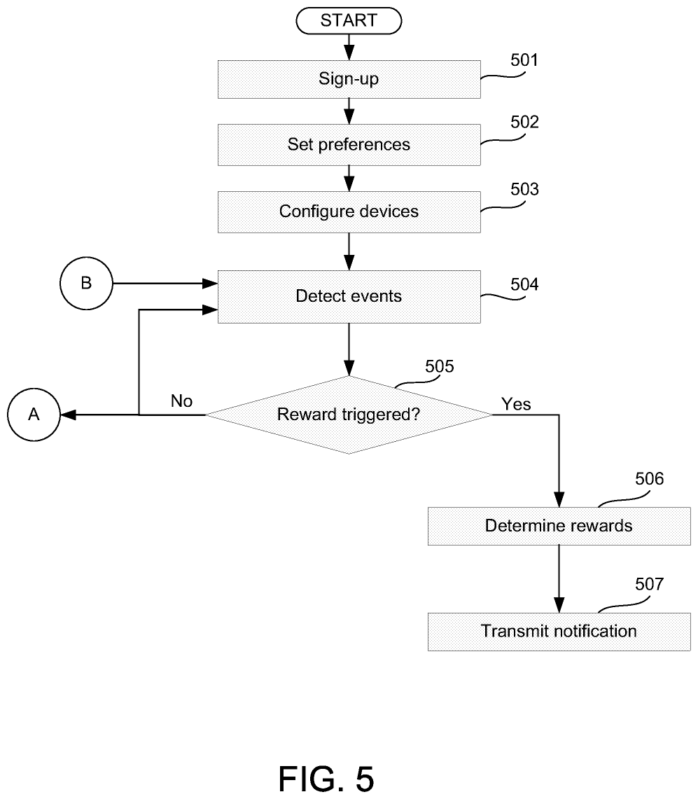

FIG. 5 illustrates a flow diagram for an example method in accordance with aspects of the present disclosure. More specifically, FIG. 5 illustrates a plurality of steps of a method for providing rewards. The steps of FIG. 5 may be performed by any of the various devices of the rewards management system disclosed herein, such as the application server 203 or computing devices of the rewards subsystem 310. One or more of the steps of FIG. 5 may be performed by executing a rewards management program and/or operating a particularly configured computing device of the rewards management system. As a result of the method of FIG. 5, rewards may be allocated to a rewards bank 312 and users may be notified of their rewards.

The method of FIG. 5 may begin with a step 501 of signing-up for a rewards service. A user or customer (e.g., an insurance policy holder) may use a mobile computing device 100m, vehicle computing device 100v, or customer computing device 100c to sign-up for a service that allows that user or customer to receive rewards. The sign-up process may be performed through a web portal provided by the application server 203 or another device of the backend system 301. For example, a user may use a web browser to navigate to a particular webpage (e.g., a MyAccount page) and sign up for a rewards service. In some embodiments, the user may be signed-up to receive rewards as part of creating a policy (e.g., an insurance policy) or as part of signing-up to receive non-reward goods or services. For example, the user might sign up for a service that collects drive data and evaluates the user's driving behavior, and in doing so, the user may also be automatically enrolled in a rewards service so that the rewards management system may allocate and maintain rewards for the user.

Signing-up at step 501 may include providing a username, password, policy number, etc. to the application server 203 and/or indicating a user's acceptance or agreement to terms and conditions. Signing-up may also include providing user information (e.g., name, birthdate, address, gender, etc.), vehicle information (e.g., make, model, year, vehicle identification number (VIN), etc.), and/or mobile computing device 100m information (e.g., smartphone identifier, smartphone make and model, phone number, etc.). Further, in step 501, upon signing-up, the rewards subsystem 310 may create and/or assign an account number or identifier (e.g., Bank ID) to the user. The rewards subsystem 310 may initialize a data structure for maintaining the account identifier in association with a number of points. The rewards subsystem 310 may also store such a data structure in the rewards bank 312. In some embodiments, merely signing up for a service or creating a policy may earn a user rewards, and thus, the rewards subsystem may also allocate rewards to the user's account in the rewards bank 312 at step 501.

In step 502, a user may set preferences. Preferences may be set in various manners. Initially, preferences may be set up through the web portal used to sign up for the rewards service. For example, preferences may be set on a webpage dedicated for a user (e.g., a MyAccount page). Preferences may be set using the mobile computing device 100m, vehicle computing device 100v, and/or customer computing device 100c. These devices may receive user inputs and transmit the inputs to the application server 203, which may record the preferences in association with the user (e.g., in association with a policy associated with the user). Some, or all, of the preferences may be stored locally on the user's device (e.g., mobile computing device 100m) or remotely in a database within the rewards subsystem 310, the rewards bank 312, or elsewhere in the backend system 301. In some embodiments, user preferences set in step 502 may be pulled from previously acquired information, such as from preferences set up when an insurance policy is opened.

One example of a preference set at step 502 may include whether the user would like to participate in a driving behavior monitoring service using his/her phone or a device plugged into (or otherwise installed) in his/her vehicle 202. For example, the user may choose between two options for collecting drive data—using a phone or device plugged into a vehicle 202. Other examples of user preferences set at step 502 may include indicating the types of rewards (e.g., points, cash, discounts, gift cards, etc.) the user would like to receive, and indicating how and when the user may receive notifications of rewards. With respect to the latter, users may indicate, for example, that they wish to receive notifications of rewards immediately upon earning the rewards, daily, weekly, etc. and may indicate that they would like to receive notifications via email, text messages (e.g., SMS, MMS, etc.), push notifications, phone calls, etc.

In step 503, the rewards management system may be configured so that rewards may be determined and allocated for particular users and notifications may be sent to particular users regarding their rewards. Configuring at step 503 may include installing or plugging in a vehicle computing device 100v in the vehicle 202 so that drive data can be collected. Additionally, or alternatively, configuring may include downloading and installing a rewards management program on a mobile computing device 100m (e.g., smartphone) to be used to collect drive data. Whether a device in the vehicle and/or a smartphone is to be used to collect drive data, configuring may also include calibration so that the device or smartphone accurately collects drive data. Configuring at step 503 may also include registering the device and/or smartphone with the application server 203 or other computing device of the backend system 301 so that the device or smartphone sending drive data can be recognized and the drive data sent can be associated with the correct user. For example, a user's mobile computing device 100m and/or vehicle computing device 100v may be provided with an activation code that may be unique to the mobile computing device 100m and/or vehicle computing device 100v. This activation code may be stored on such devices and included with data (e.g., drive data) sent from such devices so that the data may be associated with the appropriate/corresponding user.

In step 504, the rewards management system may monitor or analyze data to determine whether certain events have occurred. Events may include driving events, such as hard braking events, sharp turning events, speeding events, and other driving related events. The rewards management system (e.g., a rewards subsystem 310) may analyze drive data received from vehicle computing devices 100v or mobile computing devices 100m and determine whether driving events have occurred. For example, a vehicle computing device 100v or mobile computing device 100m may send raw GPS data and/or raw accelerometer data to the backend system 301 where a computing device 100 (e.g., a computing device of the rewards subsystem 310) may analyze the raw data and determine whether driving events have occurred using predefined thresholds, heuristics, and models. Alternatively, analysis may be performed by the vehicle computing device 100v or mobile computing device 100m and monitoring or analyzing data at the backend system 301 may include parsing messages received form the vehicle computing device 100v or mobile computing device 100m to identify driving events.

In some embodiments, monitoring or analyzing the drive data in step 504 may include determining a drive score. For example, the rewards management system may score drive data collected during a trip to obtain a drive score of 85 out of 100. Various algorithms may be used to determine drive scores. The completion of a trip and generation of a drive score may constitute a driving event in some embodiments.

Events may also include non-driving events, such as a superior (e.g., parent) monitoring the driving of a subordinate (e.g., child), a user paying their bill, a user viewing a company's website, a user reviewing their policy online, a user updating their policy information, a user adding a policy, a user viewing details of their driving history, a user taking a survey, a user taking a driving course, a user commenting on a social network (e.g., “liking” a FACEBOOK page of a particular company or “liking” a person's drive scores), and or “tweeting” certain content), and any other events/actions that a user may perform that is not directly representative of their driving behavior during a specific drive (or trip). For example, at step 504, the rewards management system may detect if a parent visits a website to view drive data or other driving reports pertaining to that parent's child. This detection may be done using cookies and other web analytic objects embedded in webpages to identify and report to, e.g., the rewards subsystem 310 when a parent visits the webpage and reviews his/her child's driving information. For example, an object may be embedded in a webpage displaying a child's driving information so that when that webpage is loaded, information is sent to the rewards management system indicating that the child's driving information has been viewed. Similar objects could be placed on other webpages to possibly reward users for visiting certain webpages.

While step 504 is performed to detect an event, step 505 is performed to determine whether the detected event triggers distribution of a reward. In other words, step 505 may include determining whether a user has earned a reward based on an event. In some embodiments, some events may trigger allocation of rewards while others might not. Also, in some embodiments, a number or sequence of events may have to occur in order to trigger rewards to be given out. Further, the same event that might trigger rewards to be given to one person, might not trigger rewards to be given to another person. For example, if an adult (who has been driving for years) obtains a drive score of 80, that adult might not receive any rewards, whereas if a teenager (who has only been driving for a year) receives the same drive score of 80, that teenager may receive rewards. By way of another example, a user with an insurance policy for three vehicles and a home may receive rewards for viewing her policy online, whereas another user with an insurance policy for only one vehicle might not receive rewards for viewing her policy online. As such, step 504 may include determining whether a particular event with respect to a particular user triggers rewards for that user. Also, in some embodiments, a user who would not otherwise receive rewards for an event might receive rewards if the user is pooling his/her rewards with a group and another member in that group would have received rewards for the same event.

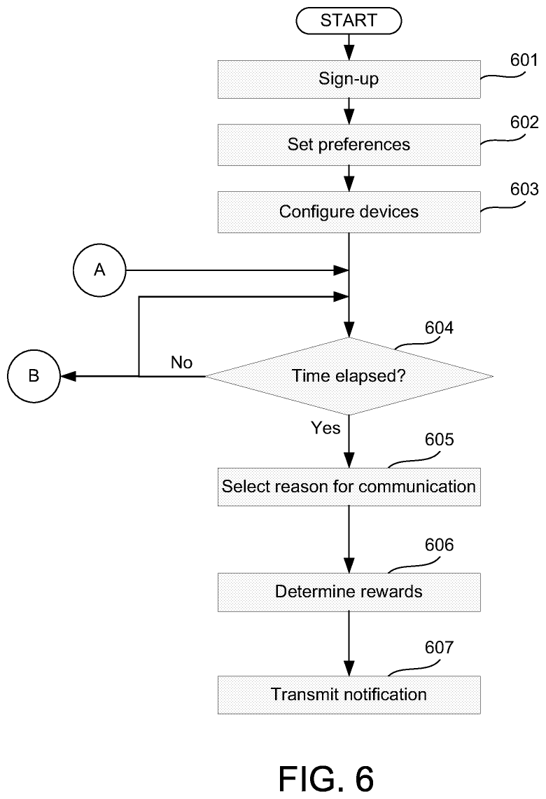

If the rewards management system determines that an event/action has not triggered rewards to be distributed (No at step 505), the rewards management system may return to step 504 to continue to monitor information to detect events. Additionally, or alternatively, in some embodiments, if it is determined that rewards have not been earned (No at step 505), the rewards management system may perform the method of FIG. 6 described below. On the other hand, if the rewards management system determines that rewards have been earned (Yes at step 505), the rewards management system may perform step 506.

In step 506, the rewards management system may determine what rewards have been earned. Determining what rewards have been earned may include determining the type of rewards that have been earned. Determining the type of rewards that have been earned may be based on preferences of the user who is to receive the rewards. For example, if the user specifies that she prefers to receive points rather than a discount on future services, the rewards management system may determine that points are to be rewarded at step 506. In some embodiments, the type of rewards selected may be related to the event that caused them to be awarded. For example, a user may be awarded a gift card to purchase gas if the event triggering the reward was a long drive without any speeding events, hard braking events, and/or sharp turning events. Or, for example, a user may be awarded a coupon for 10% off her mobile phone bill if the event triggering the reward included the user using her phone to review her drive data. Further, in some embodiments, the type of rewards selected may be based on a driving history of the user to receive the rewards. For example, if the driving history indicates that the user has performed many hard braking events, the rewards may include a 30% discount on tires. Moreover, in some embodiments, the types of rewards selected may depend on the user's characteristics, policy characteristics, or vehicle characteristics. For example, the user may receive a reward of a new speaker system designed especially for the vehicle 202 the user drives.

In addition, determining what rewards have been earned may include determining a value or magnitude of the rewards that have been earned. For example, in addition to determining that points are to be rewarded, the rewards management system may determine how many points are to be rewarded. Different users may receive a different amount of points for the same event. In other words, the number of points may be based on the particular user to whom the points will be awarded. For example, an adult who has been driving for a while may receive 10 points for a drive score of 90 whereas a teenager who has just recently learned to drive may receive 20 points for a drive score of 90. Similarly, in cases where other types of rewards (e.g., other than points) are to be offered, the rewards management system may determine the value or magnitude of those types of rewards. For example, different users may receive different amounts of cash back or different percentages of discounts, and the rewards management system may determine these different amounts and percentages based on the particular user. In some embodiments, a combination of rewards may be determined. For example, the rewards management system may determine that 10 points and a 5% discount on future insurance premiums should be awarded to a particular user based on an event.

Step 506 may also include storing the rewards in the rewards bank 312. Once the rewards are determined, the rewards management system may store the rewards in association with their recipients (e.g., with individuals users, policies, or groups). For example, if the rewards management system determines that a particular user has earned 100 points, the rewards management system may add 100 points to the particular user's bank account within the rewards bank 312. If a user's bank account within the rewards bank 312 does not have any rewards of the type being added, then adding the rewards may include creating a data structure or variable to store the value (or quantity) for the new type of rewards in association with the users' bank account. For example, if the user's bank account only has a gift certificate but the user is awarded points, the rewards management system may create a variable and assign it a value to store the number of points the user has been awarded. If additional points are awarded in the future, the rewards management system might just update the value of the already created variable.

Next, in step 507, the rewards management system may notify a user that he/she has received rewards. In some cases, the notification of rewards may include an indication of the type of rewards and/or a magnitude or value of the rewards. For example, the rewards management system may transmit a notification indicating that a user has earned or received 25 points. In some embodiments, the notification may also include a reason that the rewards are being given. For example, the notification may indicate that a user has earned $50 off new tires for their car because they drove an entire trip without any speeding events (e.g., without exceeding the speed limit or exceeding more than 5 mph over the speed limit).

The type of notification sent at step 507 may depend on user preferences, such as those preferences set in step 502. The rewards management system may be configured to transmit the notifications as an email (e.g., to an email address designated by the user), a text message (e.g., to a phone number designated by the user), a push notification (e.g., to an application running on the user's phone), or a voice message (e.g., an automatic phone call to a phone number designated by the user).

In some embodiments, the notifications may be sent soon (e.g., approximately immediately) after an event triggering the rewards is detected. Alternatively, in some embodiments, the rewards management system may send notifications in accordance with a schedule set by the user. The rewards management system may delay the sending of the notification until a next notification period. For example, if the user has indicated (e.g., as a user preference in step 502) that she would like to receive notifications only once a week, the rewards management system may accumulate rewards earned throughout the week and send one notification. That one notification, however, may list each of the rewards and the reason(s) each reward was acquired.

In some embodiments, notifications may include commentary that acknowledges that a customer is doing well (e.g., driving well) and/or that provides suggestions for improvement. Also, notifications may advise users on how they may earn additional points for another reward or reach the next level of rewards. In a case where a first user is competing against a second user, a notification to the first user may indicate that the second user is driving better and/or earning more rewards. For example, a notification may inform the first user how much safer the second user drives (e.g., that the second driver is 2× less likely to be in an accident). Notifications may also include results of a leaderboard.

FIG. 6 illustrates another flow diagram for an example method in accordance with additional aspects of the present disclosure. More specifically, FIG. 6 illustrates a plurality of steps of a method for sending positive feedback. The steps of FIG. 6 may be performed by any of the various devices of the rewards management system disclosed herein, such as the application server 203 or computing devices of the rewards subsystem 310. One or more of the steps of FIG. 6 may be performed by executing a rewards management program and/or operating a particularly configured computing device of the rewards management system. As a result of the method of FIG. 6, positive feedback, such as the receipt of rewards, may be sent to users (e.g., customers of an insurance company). Aspects of the present disclosure include possibly providing users with positive feedback even in cases when they do not perform events that trigger rewards. That is, aspects of the present disclosure may include intermittently providing users with rewards just for being customers so as to keep customers satisfied with their insurance policy and to build customer loyalty. It is contemplated that providing positive news may help improve customer retention and provide stability, which may be helpful when developing business plans and forecasting business growth. In the insurance industry, for example, a stable customer base may allow an insurance company to invest in other revenue generating resources, like roadside assistance vehicles.

The method of FIG. 6 may begin with steps 601, 602, and 603, which may be similar to steps 501, 502, and 503 of FIG. 5, respectively. Any of the features discussed above with respect to steps 501, 502, and 503 may be implemented in steps 601, 602, and 603 of the method of FIG. 6, and thus, further description of steps 61, 602, and 603 will not be provided here.

In step 604, the rewards management system may determine whether it has been too long since the last time positive feedback was provided to a user. In other words, the rewards management system may determine whether a set time has elapsed since positive feedback was last provided to a user. If the set time has not elapsed (No at step 604), the rewards management system may return to step 604 after some delay. That is, in some examples, step 604 may be repeated until a set time has elapsed since positive feedback was last provided. Additionally, or alternatively, in some embodiments, if the set time has not elapsed (No at step 604), the rewards management system may proceed to step 504 of the method of FIG. 5 described above. From this disclosure, it should be understood that the steps of FIGS. 5 and 6 may be combined to perform a process in which the rewards management system uses both time and events as triggers for notifying users of positive news or rewards. Using a combination of steps from FIGS. 5 and 6, the rewards management system may ensure that if users are not involved in actions/events that are resulting in rewards, the users are still receiving positive news intermittently (e.g., periodically). Accordingly, the rewards management system may assist a company (e.g., an insurance company) to reach out to customers in a positive way even when customers go through periods where they are not using services, such as services related to vehicle telematics, of the company.

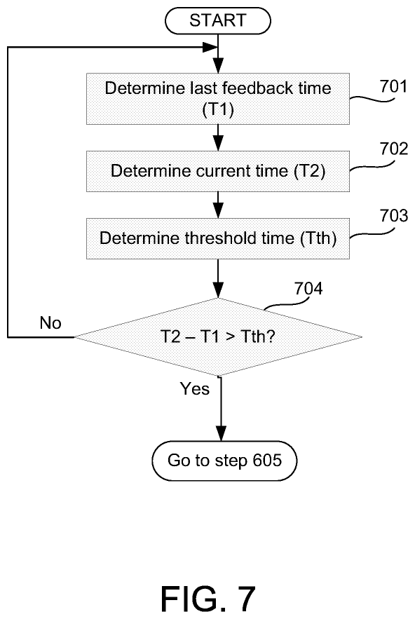

FIG. 7 illustrates steps that may be performed at step 604 to determine whether it has been too long since the last time positive feedback was provided to a user. Referring to FIG. 7, in step 701, the rewards management system may determine a time that it last provided positive feedback to a specific user. For example, the rewards management system may determine a time that it last sent a notification of rewards to a specific user. Accordingly, to facilitate this determination, the rewards management system (e.g., the rewards subsystem 310) may maintain a database storing user names or policy identifiers in association with times that rewards notifications are sent. Each time a rewards notification is transmitted, such a database may be updated with a new time corresponding to a timestamp of the transmitted rewards notification.

In step 702, the rewards management system may determine a current time (e.g., the clock time at the time the determination is being made). The rewards management system may include its own clock or use an external clock to determine the current time. In step 703, the rewards management system may determine a threshold time. This threshold time may represent the set time that may elapse before triggering the rewards management system to send positive feedback. The threshold time may be determined for a particular (or specific) user. Different threshold times may be used for different users. The rewards management system may access a database associating threshold times with certain user characteristics to determine a threshold time for a particular user.

In some embodiments, the threshold time for a particular user may be selected based on an expected impact providing positive news will have in retaining that user as a customer. Such an expected impact may be determined based on characteristics of the customer and heuristics developed based on studying the reactions of various users to the positive news. Over time, it is suspected that trends may develop that may indicate which users may be more likely to stay customers and how often those users are provided with positive news. The rewards management system may use models to account for such trends when selecting thresholds at step 703. For example, if it is determined that men between the ages of 30-35 are more likely to renew their automotive insurance policy if they receive notifications of rewards on a monthly basis, then the threshold selected at step 703 for a 32 year old male may be one month. In comparison, if it is determined that men between the ages of 30-35 are more likely to renew their automotive insurance policy if they receive notifications rewards on a weekly basis, then the threshold selected at step 703 for a 32 year old male may be one week.

Next, at step 704, the rewards management system may determine whether an amount of time elapsing since the last time positive feedback was provided exceeds the threshold time selected at step 703. Step 704 may be performed by subtracting the time T1 when positive feedback was last sent as determined in step 701 from the current time T2 determined at step 702 and comparing the difference to the threshold time Tth. If the difference is greater that the threshold time (Yes at step 704; Yes at step 604), the method may proceed to step 605. Otherwise (No at step 704), the rewards management system may return to step 701. Before repeating step 701, however, the rewards management system may wait for a period of time (e.g., implement a delay). Also, before repeating step 701, the rewards management system may clear the values determined for times T1, T2, and/or Tth.

Returning to FIG. 6, at step 605, the rewards management system may select a reason for contacting the user with positive news (e.g., a reason for giving rewards). In some embodiments, the reason may be that a time has elapsed and the user was due to receive rewards. Alternatively, rather than attributing the reason for the rewards to the elapsing of time, the rewards management system may manufacture/create a reason for providing the rewards. As such, the reward notification may seem more personalized and/or less arbitrary. Also, by selecting a reason, the rewards management system may effectively be creating an excuse to contact the user. Users may be more receptive to notifications with reasons than notifications without reasons, which can be viewed as unnecessary communications (e.g., spam or junk mail). The rewards management system may select reasons for providing rewards so that notifications of rewards are seen as positive news rather than annoying communications.

In at least one example, the selected reason may be for visiting a company website to view a policy. Even if the viewing of the website did not trigger rewards to be sent to a specific user initially, if a threshold time has been exceeded since positive news has been sent to the specific user, then the rewards management system may use the past visit to the website as a reason for providing the rewards. As another example, the selected reason could be for completing three drives using program to collect vehicle telematics information. If drive scores from the three drives did not trigger a rewards notification to be sent and the driver has not received other positive news for some period of time, the rewards management system may use the completion of the three drives as a reason to award rewards to the driver. As such, the rewards management system may positively interact with customers even though they might not be meeting expected/desired driving standards.

In light of the above, it should be understood that a wide variety of reasons (related to both driving events and non-driving events) could be selected at step 605. Also, in some cases, the reason does not have to be related to an action/event performed by a user, and could simply be a message of appreciation (e.g., “Thanks for being a customer—as a token of our appreciation we have awarded you 10 points”).

In some embodiments, the positive news may be a challenge to the user. That is, the reason for contacting the user with positive news could be a challenge that if accepted and/or met could earn the user rewards. For example, the rewards management system may determine to pose a challenge to the user explaining that the user may earn rewards if she can complete her next three trips without any hard braking events, sharp turning events, and/or speeding events. Or, for example, the rewards management system may determine to pose a challenge to the user explaining that the user is being given 5 points but can double the points if she gets a drive score above a 90 on her next drive. It should be understood that various challenges could be presented.

Still, in some embodiments, no reason may be provided for contacting the user with positive news (e.g., notifications of rewards), and thus, step 605 could be omitted.

In step 606, the rewards management system may determine what rewards are to be provided (or offered in the case of a challenge). Step 606 may be performed in a similar manner as step 506 described above. Any of the considerations for determining what rewards to provide as discussed above with respect to step 506 may be taken into consideration in step 606. For example, the rewards management system may determine rewards based on user (e.g., policy holder or customer) characteristics (e.g., gender, age, interests, etc.) and/or policy characteristics (e.g., amount of policies the customer has with a company, how many years the customer has stayed with the company, etc.). The rewards management system may also determine what rewards to provide based on how many rewards the user already has acquired. For example, the rewards management system may determine the amount of points to give the user as a percentage of the points they already accumulated. In some embodiments, if the user already has many points, the user may be given many points so that the reward has more significance. In contrast, in some embodiments, if the user already has many points, the user may be given few points so that the user is not incentivized to hoard points.

Step 606 may also include storing the determined rewards. In cases where the determined rewards are not yet awarded, and instead, are being offered as part of a challenge, the rewards management system may store the rewards in association with the condition that they are provided. Thus, the rewards management system may later determine whether the condition has been met, and whether the rewards should be released into the user's bank account in the rewards bank 312.

In step 607, the rewards management system may transmit a notification including positive news. For example, the rewards management system may transmit a message indicating that the user has been awarded rewards. Additionally, or alternatively, the rewards management system may transmit a message presenting the user with a challenge to earn rewards. Step 607 may be performed in a similar manner as step 507. For example, the notification transmitted in step 607 may be in the form of an email, text message, phone call, or push notification.

Aspects of the invention have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the invention. For example, the configuration of step 503 may take place before steps 501 or 502 and a rewards management program may be used to sign up and/or set preferences.

What is claimed is:

1. A system, comprising:
a first computing device associated with a vehicle and a user, the first computing device configured to collect drive data;
a rewards bank configured to maintain records of rewards; and
a second computing device configured to:
receive the drive data from the first computing device;
analyze the drive data to determine whether a predefined event has occurred;
determine whether the user has earned a reward based on the predefined event in response to determining that the predefined event has occurred;
determine the reward;
store the reward in association with an account of the rewards bank that is associated with the user; and
notify the user that the reward has been earned.
